(19) United States
(12) Patent Application Publication
(10) Pub. No.: US 2004/0093862 A1
(43) Pub. Date: May 20, 2004

(54) Energy from water movement

(76) Inventor: Tomislav Vucetic, Miami, FL (US)

Correspondence Address: TOMISLAV VUCETIC, 18021 Biscayne Blvd # 301, Miami, FL, 33160, US

(21) Appl. No.: 10/228,243

(22) Filed: Nov. 14, 2002

(51) Int. Cl. F03C 1/00

(52) U.S. Cl. 60/495

(57) ABSTRACT

Every mass in motion possess energy. If huge amount of water is in motion, it means that this amount of water possess huge amount of energy. Described method explains how to movement of water (tide or waves) transfer to the movement one object at the one point. From that point is easy to take energy, and use for any purpose.

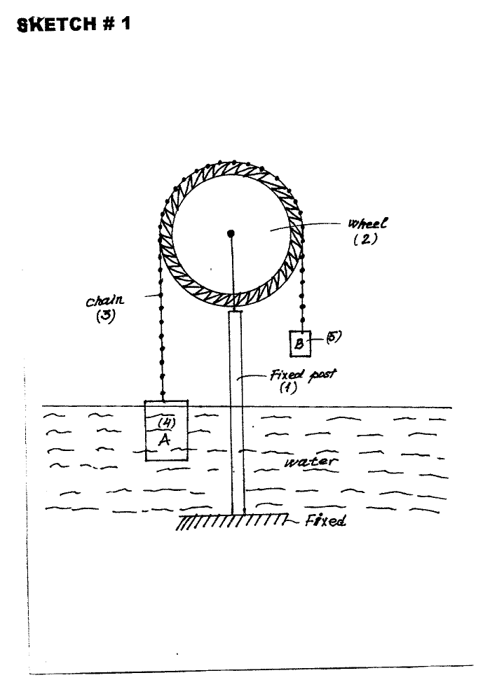

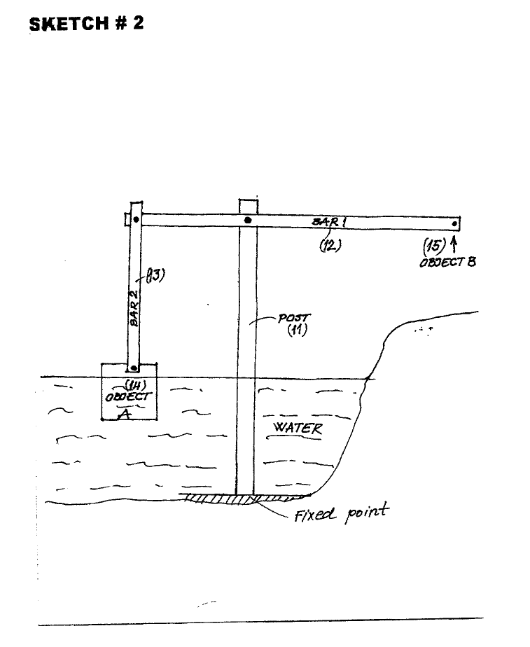

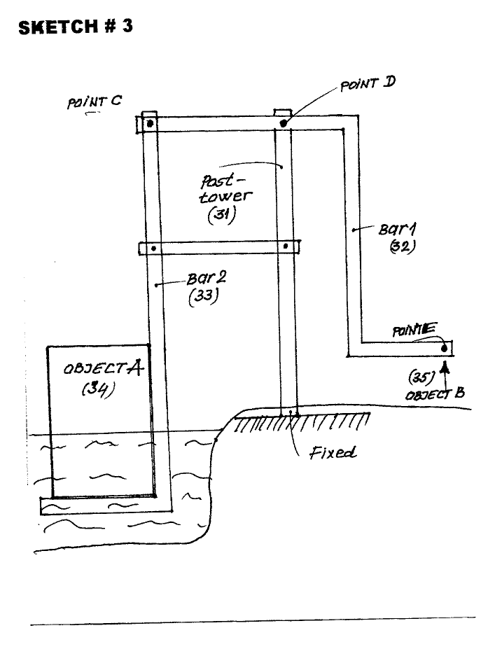

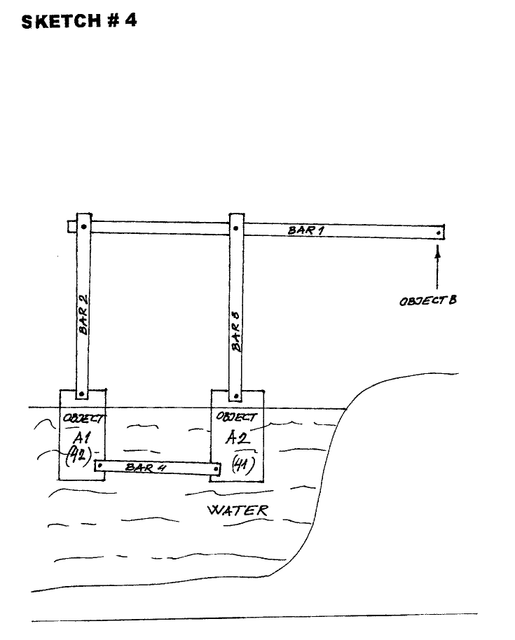

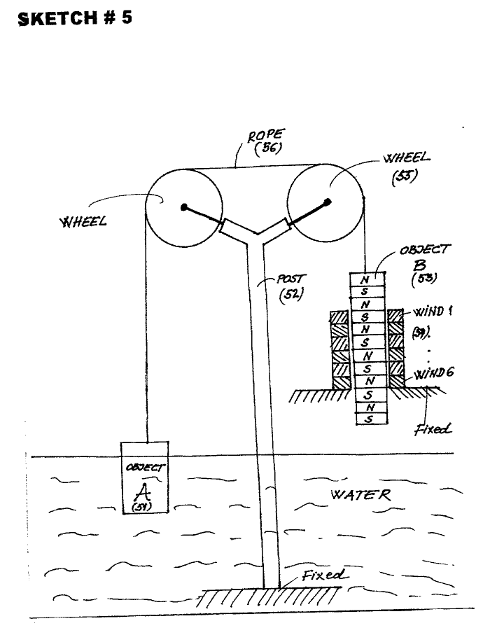

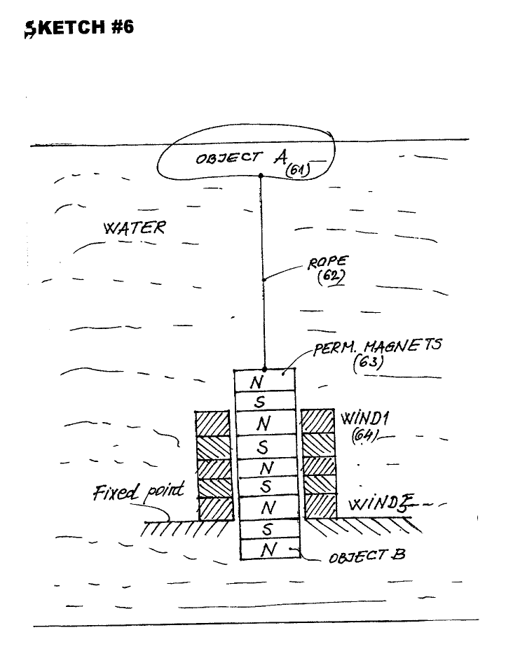

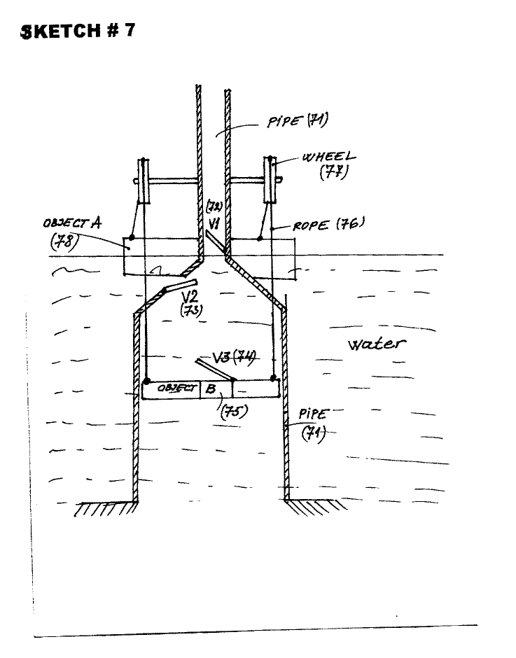

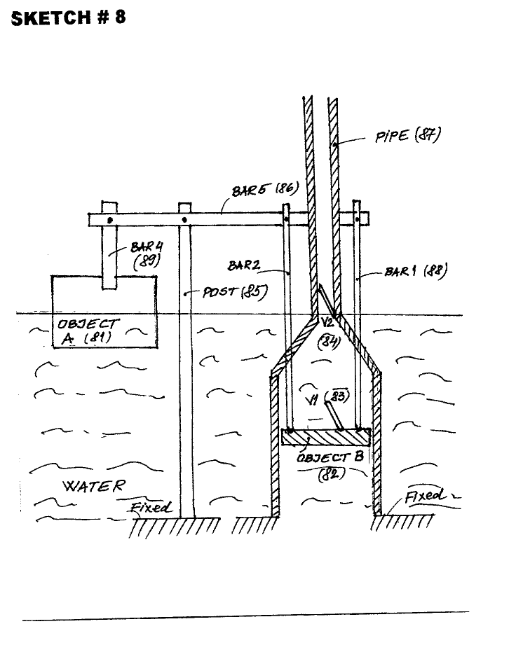

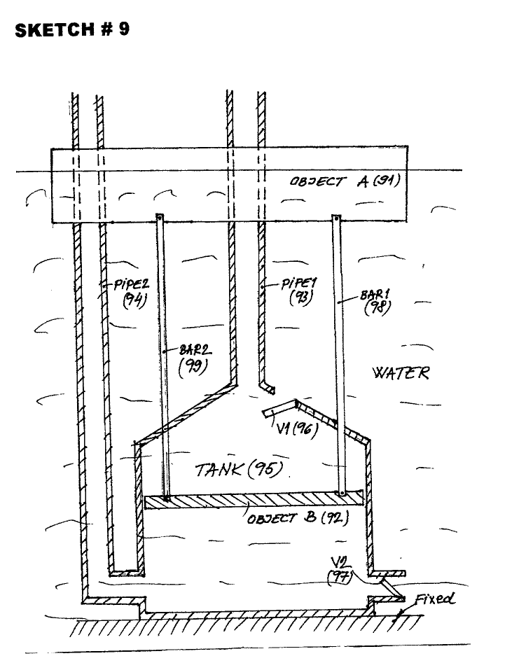

Method, also explains how to make water pump, using energy of water movement-tide or waves.

### 1) REFERENCE RELATED APPLICATION

Not Applicable

### 2) STATEMENT REGARDING FEDERALLY SPONSORED RESEARCH

Not Applicable

### 3) REFERENCE TO SEQUENCE LISTING, TABLE . . .

Not Applicable

### 4) BACKGROUND OF INVENTION

Renewable Energy Sources

### 5) BRIE SUMMARY OF INVENTION

Law in Physics says: Every object in motion possesses energy. If huge amount of water is in motion—water waves or tidal water movement—it means that amount of water possesses a huge amount of energy. Problem was how to take energy from, usually disorderly, movement of water. The method I invented, described below, takes energy from water movement and transfer that energy to the one point, and from this point allow us to use it in a easy way.

### 6) DETAILED DESCRIPTION OF THE INVENTION

6.1) Introduction

If we look how the weight machines work, we can see, that all of them basically have two sides (legs) mechanically connected over one or more fixed point of support (not movable point) in a such way that when one side moves, another side must move. On each weight machine, for example, when we put object A on side A and object B on side B, the heavier object moves its side down and side with lighter object must move up.

If we use any energy to move heavier side up, the lighter side must move down and vice versa. In another words, energy we spent to move an object on one side is transferred to the energy of moving object in another side.

6.2) How to Use Energy From Water Movement—Waves or Tidal

We can make one, out of many possible, mechanism with two sides mechanically connected trough (over) one or more point of support (not movable point) with heavier object A on side A and lighter object B on side B. If we apply any kind of energy to move object A on side A, this energy will transferred to the side B to move object B. If we put object A on side A in the water and allow water to move object A, this energy of movement object A will be transferred to the movement of object B on side B. Object B may be in the water or outside the water. Moving object B is the point where we take energy from. There are plenty possible ways how to make mechanism with two sides wich can be used to take energy, when the water moves one side. I will explain a few examples only.

### 6.3) EXAMPLE #1

Shown on Sketch #1

In the sketch #1, we have one point of support-post—(1), one teeth-wheel (2) at the top (able to move around its one axis), and the chain (3) over the teeth wheel connecting object A (4)—in the water-with object B (5)-outside the water. Object B is used to keep chine tight. When the object A (4) is moved up by the water-by waves or tide-object B (5) moves down with a little resistance and does not allow chine (5) to loose. When the water move object A (4) down the chine should catch teeth of the wheel (2), rotate it, and move object B (5) up. Process will be repeated as long as the water is able to move object A (4). Energy from rotation of teeth wheel can be used for any purpose.

If we want to take more energy from water movement, we can make more devices, the same as described above, install them next to each other and connect teeth-wheels of each one to the same axis. In this way we can cover wide area of water and increase the energy we can take from water movement.

### 6.4) EXAMPLE #2

Shown on Sketch #2

In example #2 shown on sketch #2, connection between object A (14) and object B (15) is solid, made of bar 1(12) and bar 2(13) over the fixed point of support-post (11). Post may be installed in the water or outside the water. Object A (14) may be moved by water waves or by tide. In any example object A must not sink, must be able to float. Size and weight of object A (14) is determined by the amount of water in motion. Water in motion must be able to move object A. When object A is moved by water, up and down, object B must move. Energy is taken from point where is attached object B (15). Speed of moving object A by tide is very slow, less than one millimeter per second, or so. To get higher speed at the end of bar 1 (12), where we attach object B (15), length of bar 1 from the post to the object B must be longer then from the post to the object A. In this way, slow moving object A, make object B to move faster. If for practical reason bar1 can not be too long, solution is in the next example.

### 6.5) EXAMPLE #3

Shown on Sketch #3

In example #3 we have tower (31) fixed to the ground outside the water. On the top of tower is attached bar1 (32). This point of connection is movable, bar1 (32) is able to move relative to tower (31). On the end of bar 1 (32) is connected bar 2 (33), and this point is movable, also. At the end of bar 2 is attached object A. Object B is attached at the another end of bar 1 (32), point E. If object A is moved by tidal move of water, object B must move. Moving object A (34) by tide is very slow. To get object B (35) to move faster, we have to make tower high enough to get appropriate length ratio of the bar 1 (32) between points DE and DC. Object A must be able to float when it moves down and up.

### 6.6) EXAMPLE #4

Showm on Sketch #4

In this example, instead post fixed to the ground, floating object A2 (41) is used to make fixed point of support.

Works in the same how it works in previous example. Applicable only when object A1 (42) and object A2 (42) are moved bay water waves.

### 6.7) EXAMPLE #5

Shown on Sketch #5

In this example, mechanical energy of movement of object A (51), caused by water movement, is transformed directly to electrical energy. Every generator electricity has two main parts: Stator and Rotor. Basically, stator is made of two or more windings. Rotor is made of permanent magnets. If Rotor rotate inside the Stator, electricity is made. The same is, if package of permanent magnets (53) is moved up and down inside package of windings (54), how is shown on sketch #5. Applicable when the object A (51) is moved by water waves. Suitable for remote destination where there are no connection with rest of the World.

### 6.8) EXAMPLE #6

Shown on Sketch #6

The only difference from previous example is that whole system is in the water. Object A (61) is moved by the water waves and package of permanent magnets is moved up and down inside the windings, electricity is made. Suitable in the open sea where is no other way to get electricity.

There are plenty other versions and combinations, how we can get energy from water movement, but it is not possible to list all of them. Basically all of them must have object A moved by water-waves or tide-connected with object B. When the object A is moved by water, energy is taken from the moving object B.

7) How to Make Water Pump

Based on previous method, we can make water pump, using movement of water. There are many possible versions, but I will explain only three of them.

### 7.1) EXAMPLE #7

Shown on Sketch #7

If we take one pipe (71), shown on sketch #7, and make on it two valves V1 (72) and V2 (73), with object B (75) with its own valve V3 (74), object B (75) will act like a piston. When the object A (78), in the water, connected with the rope (76) over the two wheels (77), moves up, the piston (object B (75)) moves down, closes valve V1 (72) and opens valve V2 (73) and V3 (74). Water goes inside the pipe through valve V2 (73) and valve V3 (74). When the object A (78) moves down, object B (75) must move up, closes valves V2 (73) and V3 (74) and opens valve V1 (72), push the water up trough the pipe. Process will be repeated when object A (78) move up again. In this example, to move object A may be used energy of water waves or tide energy.

### 7.2) EXAMPLE #8

Shown on Sketch #8

In this example of water pump, connection between object A (81) and object B (piston) (82) is solid made of bar 1 (88), bar 2, bar 5 (86) and bar 4 (89) over the fixed post (85). When water move object A (81) up by water wave or by tide, object B (82) must move down, opens valve V1 (83), closes valve V2 (84), water goes inside the pipe (87). When the water move object A (81)down, object moves up, closes valve V1 (83), opens valve V2(84), water goes up trough the pipe(87). Any size and weight of object A (81) may be used if water tide or wave is able to move it, but must not sink when it moves up or down.

### 7.3) EXAMPLE #9

Shown on Sketch #9

In this example of water pump, we have one tank (95), pipe 1(93), and pipe 2(94) connected how is in shown on sketch #9. Object B (92) is connected with object A (91) with bar 1(98) and bar 2(99). To move object A (91) we may use energy of water waves or tide energy. When object A (91) is moved up by the water, object B (92) must move up, closes valve V1 (96) and water must move trough pipe 1(93). When object A (91) is moved down, object B (92) move down, closes valve V2 (97), opens valve V1, and move water trough the pipe 2(94). Theoretically, size and weight of object A may be unlimited if water is able to move it.

There are many other version and combination how we can use energy of water waves or tide, to make water pump, but it is not possible to list all of them.

9) How Much Energy We Can Get

9.1) How Much Energy We Can Get from Water Waves

The exact amount of energy we can get from water waves is not possible to calculate, becouse of water waves disorderly nature, but we can use approximation to get results close to real amount.

In example #1, shown on sketch #1, object A of volume 1000 liters may be carried by the waves whose amplitude is 1 meter, which are often in the sea. Assume that object A moves up 5 seconds and moves down 5 seconds. Let see how much energy is released when one object masses 1000 kg moves 1 meter in the direction of gravity.

Mass (m) of object A is 1000 kg, acceleration of gravity (g) is 9.81 m/sec/sec, distance (d) is 1 m, and time (t) is 5 sec.

Force=m×g=1000 kg×9.81 m/sec/sec=9810 Nt˜10000 Nt.

E=F×d=10000 Nt×1 m=10000 Joule

Power=E/time=10000 Joule/5 sec=2000 Watts Average Power=1000 Watts.

From each device, where object A is moved by water waves, we can get power about 1 Kwatt with size of water waves amplitude of 1 meter. Water waves often can be more powerful may carry heavier object, appear more frequently, etc . . . All this means that there is more energy we can take from water waves if any of those occur.

We can multiply number of the same devices, cover wide area of water waves, and in this way multiply energy we can take.

9.2) How Much Energy We Can Get from the Tide

In examples where we can use tide to move object A, size and weight of object A is limited by practical reasons, only. Tidal energy may move any size and any weight of any object able to float. Theoretically, size and weight of object A moved by tidal energy, is almost unlimited. Object A may be any shape, but let's consider shape of one box with dimensions, X, Y and Z.

If dimensions of object A are: X=1000 meters, Y=1000 meters, Z=50 meters Volume of object A is: X×Y×Z=1000×1000×50=50×10 power 6 cubic meters. If object A is box filed up with water, then 1 cubic meter of water have mass of 1000 kg. Acceleration of gravity is 9.81 meter/sec/sec, we can round to 10 meter/sec/sec. Force=weight of object A with water=50×10 power 10 Nt. Tide is deferent in deferent regions, and may go up to 17 meters in some regions. Happens in predictable time, two times a day, what means that object A moved by tide, 6 hours goes up, 6 hours goes down, every 12 hours a day, which is slow, about 0.5 millimeters per second or less.

Let's assume that max tide is 10 meters, and see how much energy is released when object A moves 10 meters for six hours.

E=F×d=50×10 power 10×10=50×10 power 11 Joules. Six hours=21600 seconds, round to 20000 seconds. Power of moving object A=E/time=50×10 power 11 divided by 20000=250 Mwatts. Calculation shows, that moving object A, sizes 1000×1000×50 meters, with tide of 10 meters, may give energy of 1.5 GWhours for six hours time, which is 6 GWattshours a day. If tide is only one meter, not 10 meters, we can get 600 MWattshours energy a day for the same size of object A. Let's take another size of object A: 1000 m×500 m×10 meters. Say tide is 1 meter only. More realistic example. The same calculation shows 60 MWatthours a day, etc . . .

1. What I claim as my invention is that any mechanism (device) with at least two sides, mechanically connected in an way that when one side moves another side must move, trough one or more fixed point of support (not movable point), may be used to take energy from one side if another side is moved by any natural force. How to take energy from one side of mechanism (device), when another side is moved by waves of water or by tide, is explained in paragraph 6.3), 6.4), 6.5), 6.6), 6.7) and 6.8), and may be used any version or combination made of explained examples, #1, #2, #3, #4, #5, and #6.

2. What I claim as my invention is the method how to make water pump, based on claim #1, explained in paragraph 7.1), 7.2) and 7.3) and any other version and combination made of explained examples, #7, #8, and #9.
